(19) United States
(12) Patent Application Publication
(10) Pub. No.: US 2026/0066583 A1
(43) Pub. Date: Mar. 5, 2026

(54) ELECTRICAL CONNECTOR HAVING CONTACTS WITH POLARIZING FEATURES

(71) Applicant: TE Connectivity Solutions GmbH, Schaffhausen (CH)

(72) Inventors: Robert Yanos, New Cumberland, PA (US); John Wesley Hall, Hummelstown, PA (US); Eric DiBiaso, Lebanon, PA (US)

(21) Appl. No.: 18/818,086

(22) Filed: Aug. 28, 2024

(51) Int. Cl. H01R 13/642; H01R 13/11; H01R 13/50; H01R 13/502

(52) U.S. Cl. CPC H01R 13/642; H01R 13/111; H01R 13/501; H01R 13/502

(57) ABSTRACT

An electrical connector includes a dielectric housing including a contact channel and a longitudinal groove extending along the contact channel. The dielectric housing has a funnel associated with the longitudinal groove. The funnel has an inlet width at an inlet and an outlet width at an outlet narrower than the inlet width. The electrical connector includes a contact received in the contact channel having a mating portion and a terminating portion. The mating portion includes a polarizing feature extending therefrom received in the longitudinal groove to radially position the contact within the contact channel about the contact axis. The polarizing feature is guided into the longitudinal groove by the funnel as the polarizing feature passes from the inlet to the outlet of the funnel.

### BACKGROUND OF THE INVENTION

The subject matter herein relates generally to electrical connectors.

Electrical connectors include contacts held in a housing configured to mate with mating contacts of a mating electrical connector. It is important that contacts be properly positioned in the housing for proper mating with the mating electrical connector. For example, the contacts need to be axially positioned for proper mating. Some contacts are cylindrical, such as pin contacts or socket contacts. Such contacts may need to be radially positioned in the housing for proper mating. For example, some known contacts include split beams at the mating ends of the contact that need to be radially aligned within the housing to properly position the split beams along portions of the housing, such as wedges that interface with the split beams. It may be difficult to properly orient the contact within the housing during assembly, leading to improper positioning and/or damage to the contacts.

A need remains for an electrical connector having contacts with polarizing features for positioning of the contacts in the housing of the electrical connector.

### BRIEF DESCRIPTION OF THE INVENTION

In one embodiment, an electrical connector is provided and includes a dielectric housing extending longitudinally between a front and a rear. The front is configured to be mated with a mating electrical connector. The dielectric housing includes a contact channel extending between the front and the rear of the dielectric housing. The dielectric housing includes a longitudinal groove extending along the contact channel. The dielectric housing has a funnel associated with the longitudinal groove. The funnel has an inlet at the rear and an outlet aligned with the longitudinal groove. The funnel has an inlet width at the inlet and an outlet width at the outlet narrower than the inlet width. The electrical connector includes a contact received in the contact channel. The contact includes a contact body extending along a contact axis between a mating portion and a terminating portion. The terminating portion configured to be terminated to a wire. The mating portion configured to be mated with a mating contact of the mating electrical connector. The mating portion includes a polarizing feature extending therefrom received in the longitudinal groove to radially position the contact within the contact channel about the contact axis. The polarizing feature is guided into the longitudinal groove by the funnel as the polarizing feature passes from the inlet to the outlet of the funnel.

In another embodiment, an electrical connector is provided and includes a dielectric housing extending longitudinally between a front and a rear. The front configured to be mated with a mating electrical connector. The dielectric housing includes a contact channel extending between the front and the rear of the dielectric housing. The dielectric housing includes longitudinal grooves extending along the contact channel. The longitudinal grooves are radially spaced apart from each other about the contact channel. The dielectric housing has funnels associated with the longitudinal grooves. The funnels each have an inlet at the rear and an outlet aligned with the corresponding longitudinal groove. Each funnel has an inlet width at the inlet and an outlet width at the outlet narrower than the inlet width. The electrical connector includes a contact received in the contact channel. The contact includes a contact body extending along a contact axis between a mating portion and a terminating portion. The terminating portion configured to be terminated to a wire. The mating portion configured to be mated with a mating contact of the mating electrical connector. The mating portion includes polarizing features extending therefrom. The polarizing features are radially spaced apart from each other about the mating portion. The polarizing features received in the corresponding longitudinal grooves to radially position the contact within the contact channel about the contact axis. The polarizing features are guided into the longitudinal grooves by the corresponding funnels as the polarizing features pass from the inlets to the outlets of the funnels. The longitudinal grooves form air gaps along the mating portion to control an impedance of the contact.

In a further embodiment, an electrical connector is provided and includes a dielectric housing extending longitudinally between a front and a rear. The front configured to be mated with a mating electrical connector. The dielectric housing includes a contact channel extending between the front and the rear of the dielectric housing. The dielectric housing includes wedges extending into the contact channel proximate to the front of the dielectric housing. The dielectric housing includes longitudinal grooves extending along the contact channel. The longitudinal grooves are radially spaced apart from each other about the contact channel. The dielectric housing has funnels at the rear aligned with the longitudinal grooves. The electrical connector includes a contact received in the contact channel. The contact includes a contact body extending along a contact axis between a mating portion and a terminating portion. The terminating portion configured to be terminated to a wire. The mating portion configured to be mated with a mating contact of the mating electrical connector. The mating portion includes a socket. The mating portion includes split beams at a front of the contact configured to be mated to the mating contact. The mating portion includes polarizing features extending therefrom. The polarizing features are radially spaced apart from each other about the mating portion. The polarizing features received in the corresponding longitudinal grooves to radially position the contact within the contact channel about the contact axis. The polarizing features are guided into the longitudinal grooves by the corresponding funnels. The split beams are aligned with the wedges by the longitudinal grooves to position the split beams on opposite sides of the wedges.

### BRIEF DESCRIPTION OF THE DRAWINGS

FIG. 1 is a perspective view of an electrical connector in accordance with an exemplary embodiment.

FIG. 2 is a front perspective view of the cable assembly in accordance with an exemplary embodiment.

FIG. 3 is an exploded view of the cable assembly 10 in accordance with an exemplary embodiment.

FIG. 4 is a front perspective view of one of the contacts in accordance with an exemplary embodiment.

FIG. 5 is a rear perspective view of one of the contacts in accordance with an exemplary embodiment.

FIG. 6 is a rear view of the dielectric housing in accordance with an exemplary embodiment.

FIG. 7 is an enlarged, rear view of a portion of the dielectric housing in accordance with an exemplary embodiment.

FIG. 8 is a rear view of the cable assembly showing the contacts loaded into the dielectric housing and showing the outer shield surrounding the dielectric housing in accordance with an exemplary embodiment.

FIG. 9 is a front view of the cable assembly showing the contacts loaded into the dielectric housing and showing the outer shield surrounding the dielectric housing in accordance with an exemplary embodiment.

FIG. 10 is a cross-sectional view of the cable assembly showing the contacts loaded into the dielectric housing in accordance with an exemplary embodiment.

FIG. 11 is a cross-sectional view of the cable showing the contacts loaded into the dielectric housing in accordance with an exemplary embodiment.

FIG. 12 is a cross-sectional view of a portion of the cable assembly showing one of the contacts loaded in the dielectric housing in accordance with an exemplary embodiment.

### DETAILED DESCRIPTION OF THE INVENTION

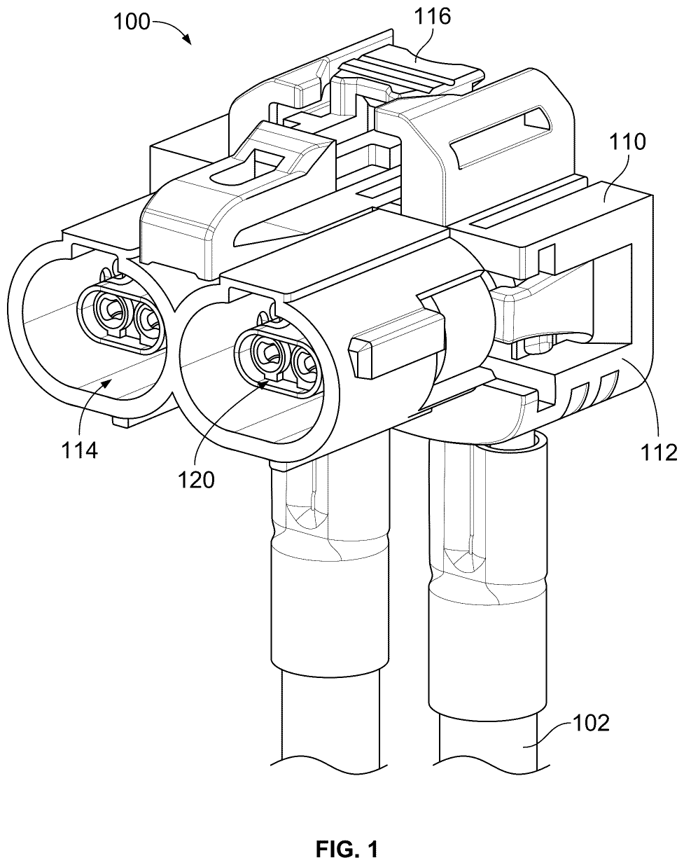

FIG. 1 is a perspective view of an electrical connector 100 in accordance with an exemplary embodiment. The electrical connector 100 is configured to be mated with a mating electrical connector (not shown). In the illustrated embodiment, the electrical connector 100 is a receptacle connector configured to be mated with a plug connector. In alternative embodiments, the electrical connector 100 may be a plug connector configured to be mated with a receptacle connector. In an exemplary embodiment, the electrical connector 100 is a cable connector provided at an end of one or more cables 102. The mating electrical connector may also be a cable connector. Alternatively, the mating electrical connector may be a board connector mounted to a printed circuit board. In various embodiments, the electrical connector 100 may be a header connector configured to be mounted to another component, such as a panel, a wall, a chassis, a circuit board, or another component.

The electrical connector 100 includes a connector housing 110 holding one or more cable assemblies 120. In the illustrated embodiment, the connector housing 110 holds a pair of the cable assemblies 120. However, the connector housing 110 may be designed to hold greater or fewer cable assemblies 120 in alternative embodiments. In the illustrated embodiment, the cable assemblies 120 are arranged side-by-side. Other arrangements are possible in alternative embodiments, such as having the cable assemblies 120 stacked above and below each other.

The connector housing 110 includes walls 112 forming a cavity 114 that receives the cable assemblies 120. The mating electrical connector may be plugged into the cavity 114 to mate with the cable assemblies 120. For example, the connector housing 110 may be open at the front to provide access to the cavity 114 and the cable assemblies 120 to receive the mating electrical connector. The cables 102 extend from the connector housing 110. For example, the cables 102 may extend from the rear of the connector housing 110 and/or the bottom of the connector housing 110. The connector housing 110 includes a latching feature, such as a connector latch 116, used to secure the mating electrical connector in the cavity 114. In the illustrated embodiment, the connector latch 116 is a latch pocket configured to receive a deflectable latch of the mating electrical connector. Other types of latching features may be provided in alternative embodiments, such as a deflectable latch used to electrically coupled to the mating electrical connector. In various embodiments, the connector housing 110 may include guide features and/or keying features to control mating with the mating electrical connector.

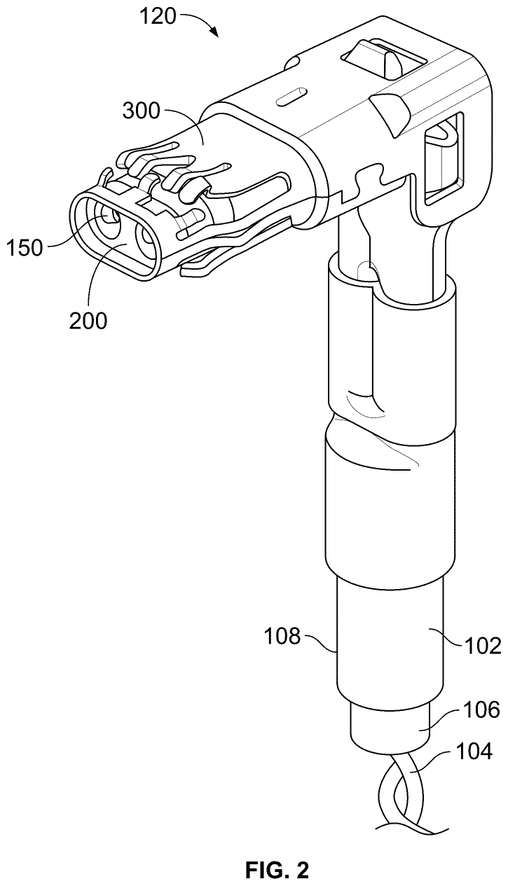

FIG. 2 is a front perspective view of the cable assembly 120 in accordance with an exemplary embodiment. In an exemplary embodiment, the cable assembly 120 is a signal assembly configured to transmit data signals. However, the cable assembly may additionally or alternatively be a power assembly configured to transmit power. In various embodiments, the cable assembly 120 includes multiple signal lines to connect the cable 102 and the mating electrical connector. For example, the cable assembly 120 may include a pair of signal lines configured to convey a differential pair signal. However, the cable assembly 120 may include greater or fewer than two signal lines therethrough. In an exemplary embodiment, the cable assembly 120 is a high-speed cable assembly. For example, the cable assembly 120 may be a multi-gigabit cable assembly. In various embodiments, the cable assembly 120 may provide a bandwidth up to 15 GHz or greater. In various embodiments, the cable assembly 120 may support data transmission up to 56 Gbps or greater.

The cable assembly 120 is terminated to an end of the cable 102. For example, the cable assembly 120 may be terminated to ends of wires 104 of the cable 102. In the illustrated embodiment, the cable 102 includes a differential pair of wires, such as a twisted-pair of the wires 104 or a parallel pair of the wires 104. However, in alternative embodiments, the cable 102 may include greater or fewer wires 104, such as including multiple twisted pairs of the wires 104. In other alternative embodiments, the wires 104 may be single ended wires rather than twisted-pair wires. In other various embodiments, the cable 102 may include a single conductor. In an exemplary embodiment, the cable 102 is a shielded cable having a cable shield 106 surrounding the wires 104 to provide electrical shielding for the wires 104. The cable 102 includes an outer jacket 108 surrounding the cable shield 106.

In an exemplary embodiment, the cable assembly 120 includes one or more contacts 150, a dielectric housing 200 holding the contacts 150, and an outer shield 300 surrounding at least a portion of the dielectric housing 200 to provide electrical shielding around the dielectric housing 200 and the contacts 150 held by the dielectric housing 200. In an exemplary embodiment, the outer shield 300 completely surrounds the dielectric housing 200 and the contacts 150 to provide complete shielding for the contacts 150 between the cable 102 and the mating interface configured to be mated with the mating electrical connector. The outer shield 300 provides 360° shielding around the end of the cable 102 and the contacts 150. For example, the outer shield 300 provides shielding along the top, the bottom, the sides, the front, and the rear of the cable assembly 120 to provide efficient electrical shielding along the signal transmission lines.

In the illustrated embodiment, the cable assembly 120 includes a pair of the contacts 150. The contacts 150 are configured to be terminated to the ends of the corresponding wires 104 of the cable 102. The outer shield 300 is configured to be terminated to the cable shield 106 of the cable 102, either directly or through a ferrule or other connecting element, to create a common ground path between the cable 102 and the cable assembly 120.

In an exemplary embodiment, the cable assembly 120 is a right-angle cable assembly. The contacts 150 are right angle contacts having a 90° bend along the contacts 150 to transition between the mating ends of the terminating ends of the contacts 150. In the illustrated embodiment, the cable 102 extends from the bottom of the cable assembly 120. The cable 102 generally extends along a cable axis that is perpendicular to the mating axis of the cable assembly 120. The cable 102 may extend from other portions of the cable assembly 120, such as the side or the top in alternative embodiments. The cable 102 may extend at other angles other than a right angle in alternative embodiments.

In alternative embodiments, the cable assembly 120 is a straight or pass-through cable assembly. The contacts 150 in such assembly are linear extending along a linear cable axis. The cable 102 extends parallel to the mating end in such assembly. For example, the cable 102 may extend from the rear of the assembly.

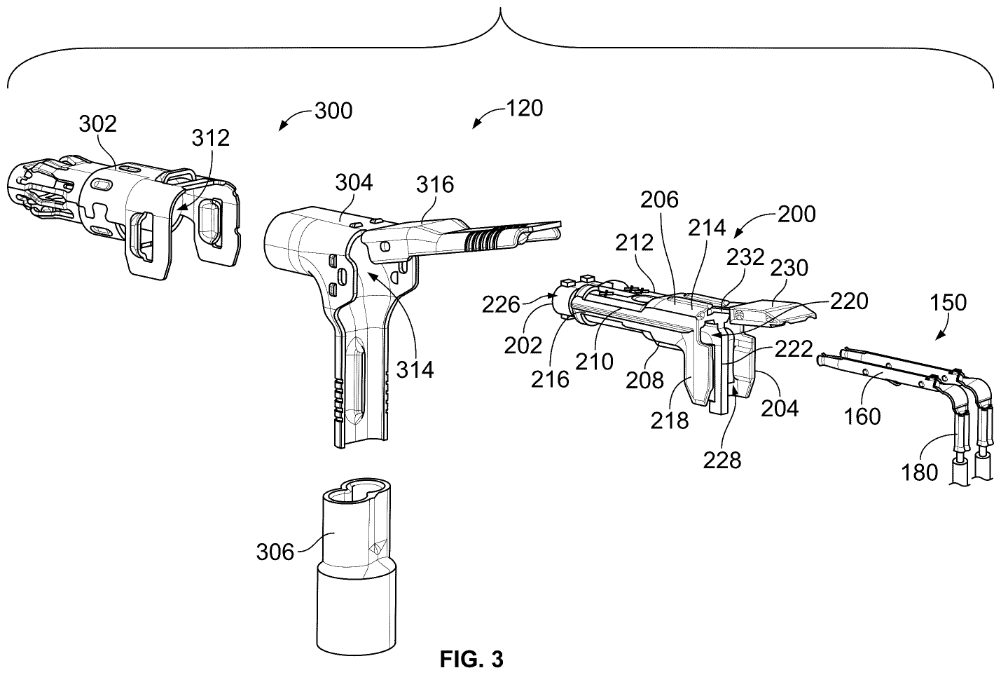

FIG. 3 is an exploded view of the cable assembly 120 in accordance with an exemplary embodiment. FIG. 3 shows the contacts 150, the dielectric housing 200, and the outer shield 300. In the illustrated embodiment, the outer shield 300 is a multi-piece shield having a front shield 302, a rear shield 304, and a ferrule 306 for the cable 102 configured to be coupled to the rear shield 304 to mechanically and electrically connect the cable 102 to the outer shield 300. The rear shield 304 is separate and discrete from the front shield 302 and configured to be electrically coupled to the front shield 302, such as by crimping, laser welding, or other connecting process. However, in alternative embodiments, the outer shield 300 may be a single piece shield rather than the multi-piece shield.

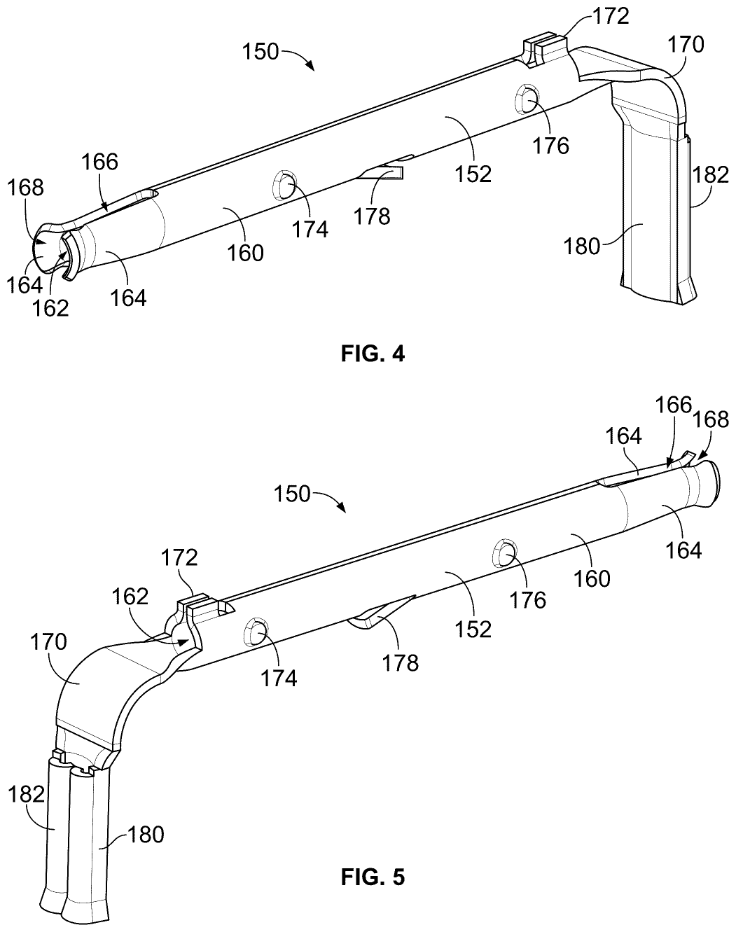

With additional reference to FIG. 4, which is a front perspective view of one of the contacts 150 in accordance with an exemplary embodiment, and FIG. 5, which is a rear perspective view of one of the contacts 150 in accordance with an exemplary embodiment, each contact 150 includes a contact body 152 extending between a mating portion 160 and a terminating portion 180. In an exemplary embodiment, the contact body 152 is a stamped and formed structure stamped from a metal sheet and formed into a desired shape. For example, the contact body 152 is a unitary structure having the mating portion 160 integral with the terminating portion 180.

The mating portion 160 is configured to be mated with a mating contact of the mating electrical connector. In the illustrated embodiment, the mating portion 160 includes a socket 162 configured to receive a pin defining the mating contact of the mating electrical connector. Other types of mating portions may be provided in alternative embodiments, such as a pin, a spring beam, a blade, or another type of mating portion. In an exemplary embodiment, the mating portion 160 is formed into a cylindrical or tubular structure to define the socket 162. The mating portion 160 may have other shapes in alternative embodiments.

The terminating portion 180 is configured to be terminated to the wire 104 of the cable 102. In the illustrated embodiment, the terminating portion 180 includes a crimp barrel 182 configured to be crimped to the wire 104. Other types of terminating portions may be provided in alternative embodiments, such as a weld pad or solder pad configured to be welded or soldered to the wire 104, or an insulation displacement contact.

In an exemplary embodiment, the contact body 152 includes a transition 170 between the mating portion 160 and a terminating portion 180. In the illustrated embodiment, the transition 170 includes a bend or fold that orients the terminating portion 180 transverse relative to the mating portion 160. For example, the transition 170 may have a 90° bend to form a right-angle contact. In the illustrated embodiment, the terminating portion 180 is oriented perpendicular to the mating portion 160. For example, the mating portion 160 is oriented generally horizontally and the terminating portion 180 is oriented generally vertically. However, in alternative embodiments, the transition 170 may be planar or axial to orient the terminating portion 180 axially in line with the mating portion 160.

In an exemplary embodiment, the mating portion 160 includes a split beam interface including a plurality of mating beams 164 at the front of the contact body 152. The mating beams 164 are separated by gaps 166 that allow the mating beams 160 to move independently of each other. Optionally, the mating beams 164 may be bent inward toward each other to narrow the diameter of the socket 162 for receipt of the end contact to ensure electrical contact between the mating portion 160 and the mating contact. The distal ends of the mating beams 164 may be flared outward to form a funnel 168 to guide the pin into the socket 162. The mating beams 164 may be deflected outward when the pin is plugged into the socket 162. The split beam interface of the mating portion 160 may form a tulip style mating contact.

In the illustrated embodiment, the mating portion 160 includes a pair of the mating beams 164 on opposite sides of the socket 162. The mating portion 160 may include greater or fewer mating beams 164 in alternative embodiments. In the illustrated embodiment, the mating beams 164 are provided on the right and left sides of the mating portion 160 in the gaps 166 are provided at the top and the bottom of the mating portion 160. Other relative positions are possible in alternative embodiments.

In an exemplary embodiment, the mating portion 160 includes one or more orientation tabs 172 used to orient the contact 150 relative to the dielectric housing 200. In the illustrated embodiment, the orientation tabs 172 are located at the rear end of the mating portion 160. Other locations are possible in alternative embodiments. In the illustrated embodiment, the orientation tabs 172 are located at the top of the mating portion 160. Other locations are possible in alternative embodiments. Optionally, the orientation tabs 172 are aligned with the gaps 166. Alternatively, the orientation tabs 172 may be aligned with the mating beams 164.

In an exemplary embodiment, the mating portion 160 includes one or more polarizing features 174 extending from the mating portion 160. The polarizing features 174 are configured to interface with the dielectric housing 200 to locate the contact 150 relative to the dielectric housing 200. In an exemplary embodiment, each polarizing feature 174 includes a protrusion 176 protruding from the exterior surface of the contact body 152. The protrusion 176 is formed integral with the contact body 152. For example, the protrusion 176 may be stamped and/or formed from the contact body 152. For example, the protrusion 176 may be formed by a pressing operation, such as coining, swaging, bending, punching, flaring, or otherwise forming the protrusion 176 from the contact body 152. In various embodiments, the protrusion 176 may be created by forming a dimple on the interior surface of the contact body 152 to form the protrusion 176 protruding from the exterior side of the contact body 152. In other various embodiments, the protrusion 176 may be formed by a stamping process to stamp a beam, tab, or other structure that is bent outward to form the protrusion 176.

In an exemplary embodiment, the mating portion 160 includes a plurality of the polarizing features 174. The polarizing features 174 may be arranged on opposite sides of the mating portion 160, such as the right side and the left side of the mating portion 160 or the top side and the bottom side of the mating portion 160. In an exemplary embodiment, the polarizing features 174 our radially offset from each other. For example, the polarizing features 174 may be radially offset 180° from each other. In an exemplary embodiment, the polarizing features 174 may be axially offset from each other. For example, the mating portion 160 may include forward polarizing features closer to the front end of the mating portion 160 and rearward polarizing features closer to the rear end of the mating portion 160.

In an exemplary embodiment, the mating portion 160 includes a locking lance 178 extending therefrom. The locking lance 178 may be used to secure the contact 150 in the dielectric housing 200. In the illustrated embodiment, the locking lance 178 is located along the bottom of the mating portions 160. Other locations are possible in alternative embodiments. Optionally, multiple locking lances 178 may be provided.

With reference back to FIG. 3, the dielectric housing 200 is used to hold the contacts 150 relative to each other, such as for mating with the mating electrical connector. The dielectric housing 200 is manufactured from a dielectric material, such as a plastic material. In an exemplary embodiment, the dielectric housing 200 is manufactured by a molding process, such as an injection molding process.

The dielectric housing 200 extends between a front 202 and a rear 204. The dielectric housing 200 includes a top 206 and a bottom 208. The dielectric housing 200 includes a first side 210 and a second side 212. In an exemplary embodiment, the dielectric housing 200 includes a base 214, a front portion 216 extending forward from the base 214, and a rear portion 218 extending rearward from the base 214. In an exemplary embodiment, the front portion 216 receives and supports the mating portions 160 of the contacts 150 and the rear portion 218 receives and supports the terminating portions 180 of the contacts 150. The front portion 216 may define a nose cone at the front 202 of the dielectric housing 200 configured to surround and support the mating portions 160 of the contacts 150. The rear portion 218 may define a platform or tray configured to support the terminating portions 180 of the contacts 150.

In an exemplary embodiment, the dielectric housing 200 includes contact channels 220 configured to receive the corresponding contacts 150. The dielectric housing 200 may include multiple contact channels 220 or a single contact channel 220 depending on the particular application. In the illustrated embodiment, the dielectric housing 200 includes a pair of the contact channels 220 to receive the pair of the contacts 150. Greater or fewer contact channels 220 may be provided in alternative embodiments. In an exemplary embodiment, the contact channels 220 are arranged in a row between the first side 210 and the second side 212. For example, the contact channels 220 are arranged side-by-side with a separating wall 222 between the contact channels 220. The separating wall 222 is a contact separator between the contacts. The separating wall 222 may be a wire separator between the wires. The separating wall 222 electrically isolates the contacts 150 from each other within the contact channels 220.

In an exemplary embodiment, each contact channel 220 includes a front contact channel 226 and a rear contact channel 228. The front contact channel 226 passes through the front portion 216 and receives the mating portion 160 of the corresponding contact 150. The rear contact channel 228 passes through the rear portion 218 and receives the terminating portion 180 of the corresponding contact 150. In the illustrated embodiment, the rear contact channel 228 extends along a path transverse to the path of the front contact channel 226. For example, the rear contact channel 228 may be oriented generally perpendicular to the front contact channel 226. The rear contact channel 228 may be oriented at other angles in alternative embodiments. In embodiments that receive straight contacts 150 (rather than a right-angle contacts), the rear contact channel 228 may be oriented generally parallel to the front contact channel 226.

In an exemplary embodiment, the front contact channel 226 is completely surrounded by the dielectric housing 200. For example, the front contact channel 226 may be a generally cylindrical tube or bore passing through the front portion 216 of the dielectric housing 200 with the dielectric housing 200 providing 360° covering around the front contact channel 226 along the entire length of the front contact channel 226. However, the front contact channel 226 may include openings providing access to the front contact channel 226 in various embodiments. In an exemplary embodiment, the contact 150 may be rear loaded into the front contact channel 226 through the rear 204 of the dielectric housing 200.

In an exemplary embodiment, the rear contact channel 228 is open at the rear 204 of the dielectric housing 200. For example, the rear contact channel 228 may be surrounded on three sides by the dielectric housing 200, such as the front, the right side, and left side of the rear contact channel 228, but the rear of the rear contact channel 228 may be open. The rear contact channel 228 is open at the rear to receive the contact 150.

In an exemplary embodiment, the dielectric housing 200 includes a housing cover 230 at the rear 204. The housing cover 230 is configured to be coupled to the rear 204 to close the rear contact channel 228. The housing cover 230 is used to cover the terminating ends 180 of the contacts 150 and the rear contact channels 220. In an exemplary embodiment, the housing cover 230 is connected to the base 214 of the dielectric housing 200 by a hinge 232. In an exemplary embodiment, the hinge 232 and the housing cover 230 are integral with the dielectric housing 200. For example, the dielectric housing 200, the hinge 232, and the housing cover 230 may be co-molded during a common molding process to form a unitary, monolithic structure. The hinge 232 may be a living hinge. In the illustrated embodiment, the hinge 232 is located at the top 206 of the dielectric housing 200. The housing cover 230 is supported at the top 206 of the dielectric housing 200 and is configured to be closed by rotating the housing cover 230 downward to connect the housing cover 230 to the rear 204 of the dielectric housing 200. Other mounting locations and closing processes may be utilized in alternative embodiments. For example, in embodiments that receive straight contacts (rather than right angle contacts, the rear contact channels 228 may be open at the top and the housing cover 230 may be closed to cover the top of the dielectric housing 200 along the rear contact channels 228.

The outer shield 300 provides shielding for the contacts 150. The dielectric housing 200 positions the contacts 150 relative to the outer shield 300 and is used to electrically isolate the contacts 150 from the outer shield 300. In the illustrated embodiment, the outer shield 300 includes the front shield 302 and the rear shield 304. In an exemplary embodiment, the front shield 302 is a stamped and formed part stamped from a metal sheet and formed into a desired shape. The front shield 302 includes a front cavity 312 that receives the front portion of the dielectric housing 200. The front shield 302 extends along and provides shielding for the front portion 216 of the dielectric housing 200. In an exemplary embodiment, the rear shield 304 is a stamped and formed part stamped from a metal sheet and formed into a desired shape. The rear shield 304 includes a rear cavity 314 that receives the rear portion of the dielectric housing 200. The rear shield 304 includes a shield cover 316 that closes the rear cavity 314. The rear shield 304 extends along and provides shielding for the rear portion 218 of the dielectric housing 200.

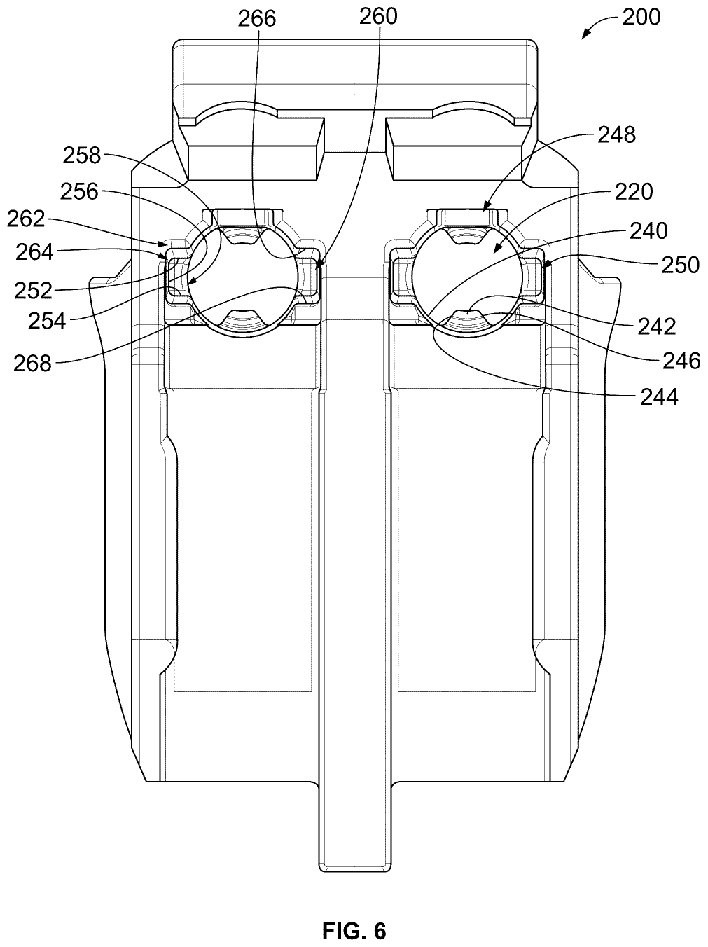

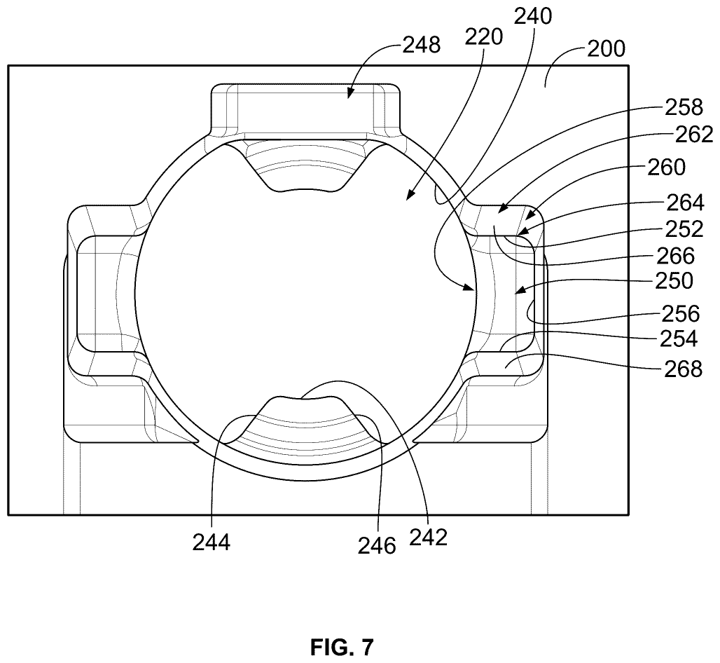

FIG. 6 is a rear view of the dielectric housing 200 in accordance with an exemplary embodiment. FIG. 7 is an enlarged, rear view of a portion of the dielectric housing 200 in accordance with an exemplary embodiment. FIGS. 6 and 7 show the contact channels 220 of the dielectric housing 200.

Each contact channel 220 extends through the dielectric housing 200 to receive the corresponding contact 150. The contact channel 220 has an interior surface 240 surrounding the contact channel 220. In an exemplary embodiment, the interior surface 240 forms a generally cylindrical bore through the dielectric housing 200 that receives the contact 150. The generally cylindrical contact channel 220 receives the generally cylindrical contact 150 and allows some rotation of the contact 150 within the contact channel 220. For example, the contact 150 may be rotated to an alignment position within the contact channel 220. In an exemplary embodiment, the contact channel 220 includes alignment features configured to align the contact 150 within the contact channel 220. Proper alignment of the contact 150 in the contact channel 220 improves cable assembly reliability and reduces scrap rate for cable assemblies due to non-functionality of the cable assembly or damage to the contacts.

In an exemplary embodiment, the dielectric housing 200 includes one or more wedges 242 extending into the contact channel 220 from the interior surface 240. The wedges 242 are used, in conjunction with the mating beams 164, to create a lead-in or funnel for the mating contact. In an exemplary embodiment, the wedges 242 are located at the front of the dielectric housing 200. The wedges 242 are configured to interface with the front portion of the contact 150. The wedges 242 include wedge surfaces 244, 246 angled relative to each other to form a generally wedge-shaped structure. In an exemplary embodiment, the wedges 242 are configured to interface with the split mating beams 164 (shown in FIG. 4) of the contact 150. The wedges 242 are configured to be received in the gaps 166 between the mating beams 164. The mating face of the wedges 242, in conjunction with the terminal tulip defined by the distal ends of the mating beams 164, provide the lead-in function for the mating contact. The contact 150 needs to be positioned in the contact channel 220 in a proper orientation relative to the wedges 242 to interface the mating beams 164 with the wedges 242. For example, the gaps 166 need to be aligned with the wedges 242. The contact channel 220 includes alignment features configured to align the gaps 166 with the wedges 242.

In an exemplary embodiment, the dielectric housing 200 includes an orientation pocket 248. The orientation pocket 248 is configured to receive the orientation tab(s) 172 of the contact 150. The orientation pocket 248 is open at the interior surface 240 to the contact channel 220 to receive the orientation tabs 172. The orientation pocket 248 is used to orient the contact 150 relative to the dielectric housing 200. In the illustrated embodiment, the orientation pocket 248 is located at the rear of the dielectric housing 200. Other locations are possible in alternative embodiments. In the illustrated embodiment, the orientation pocket 248 is located at the top of the contact channel 220. Other locations are possible in alternative embodiments. Optionally, the orientation pocket 248 is aligned with the wedges 242. The orientation pocket 248 may be generally rectangular in shape. Optionally, the orientation pocket 248 may include a chamfered lead in surfaces to guide the orientation tabs 172 into the orientation pocket 248.

In an exemplary embodiment, the dielectric housing 200 includes one or more longitudinal grooves 250 extending along the contact channel 220. The longitudinal grooves 250 are configured to receive the polarization features 174 (shown in FIG. 4) of the contact 150. The longitudinal grooves 250 are used to align the contact 150 in the contact channel 220 by locating the polarization features 174 at predetermined radial positions. When the polarization features 174 are located in the longitudinal grooves 250, the contact 150 as limited rotational movement within the contact channel 220. The longitudinal grooves 250 align the contact 150 with the wedges 242. For example, the gaps 166 are aligned with the wedges 242 when the polarization features 174 are located in the longitudinal grooves 250. The longitudinal grooves 250 align the contact 150 with the orientation pocket 248. For example, the orientation tabs 172 are aligned with the orientation pocket 248 when the polarization features 174 are located in the longitudinal grooves 250.

In an exemplary embodiment, the longitudinal groove 250 includes a first groove wall 252, a second groove wall 254 opposite the first groove wall 252, and an outer wall 256 between the first and second groove walls 252, 254. The outer wall 256 and the first and second groove walls 252, 254 form a void that defines the longitudinal groove 250. The outer wall 256 is located opposite an opening 258 to the contact channel 220 between the first and second groove walls 252, 254. The opening 258 is located at the interior surface 240. The opening 258 opens the longitudinal groove 250 to the contact channel 220 to receive the polarization feature 174 of the contact 150. In an exemplary embodiment, the first and second groove walls 252, 254 are parallel to each other and perpendicular to the outer wall 256. In other various embodiments, the first and second groove walls 252, 254 may be angled relative to each other such that the longitudinal groove 250 is wider at the opening 258 and narrower at the outer wall 256.

In an exemplary embodiment, the dielectric housing 200 includes a funnel 260 associated with the longitudinal groove 250. The funnel 260 is located at the rear of the contact channel 220 to receive the polarization feature 174 and guide the polarization feature 174 into the longitudinal groove 250. The funnel 260 tapers inward from the rear to the longitudinal groove 250 to guide the polarization feature 174 into the longitudinal groove 250. In an exemplary embodiment, the funnel 260 includes an inlet 262 at the rear and an outlet 264 at the longitudinal groove 250. The funnel 260 is wider at the inlet 262 and narrower at the outlet 264. For example, the funnel 260 has an inlet width at the inlet 262 in an outlet width at the outlet 264 that is narrower than the inlet width. In an exemplary embodiment, the funnel 260 includes a first funnel wall 266 and a second funnel wall 268 extending between the inlet 262 and the outlet 264. The first and second funnel walls 266, 268 are angled relative to the longitudinal axis of the contact channel 220. The first and second funnel walls 266, 268 are angled inward from the rear to the longitudinal groove 250 to guide the polarization feature 174 into longitudinal groove 250. Optionally, the first and second funnel walls 266, 268 may be curved between the inlet 262 and the outlet 264. Alternatively, the first and second funnel walls 266, 268 may be flat between the inlet 262 and the outlet 264.

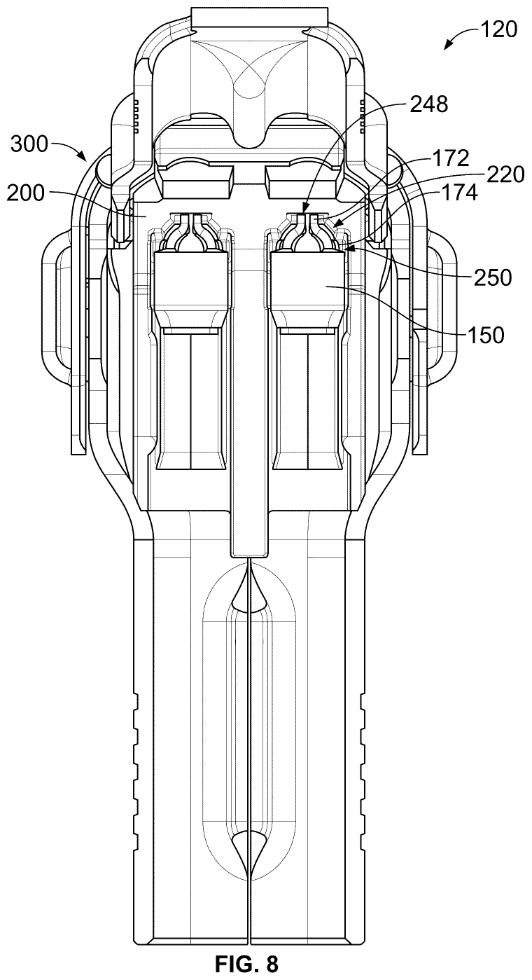

FIG. 8 is a rear view of the cable assembly 120 showing the contacts 150 loaded into the dielectric housing 200 and showing the outer shield 300 surrounding the dielectric housing 200. When assembled, the contact 150 is located in the contact channel 220. The polarization features 174 are received in the corresponding longitudinal grooves 250. The orientation tabs 172 are received in the orientation pocket 248.

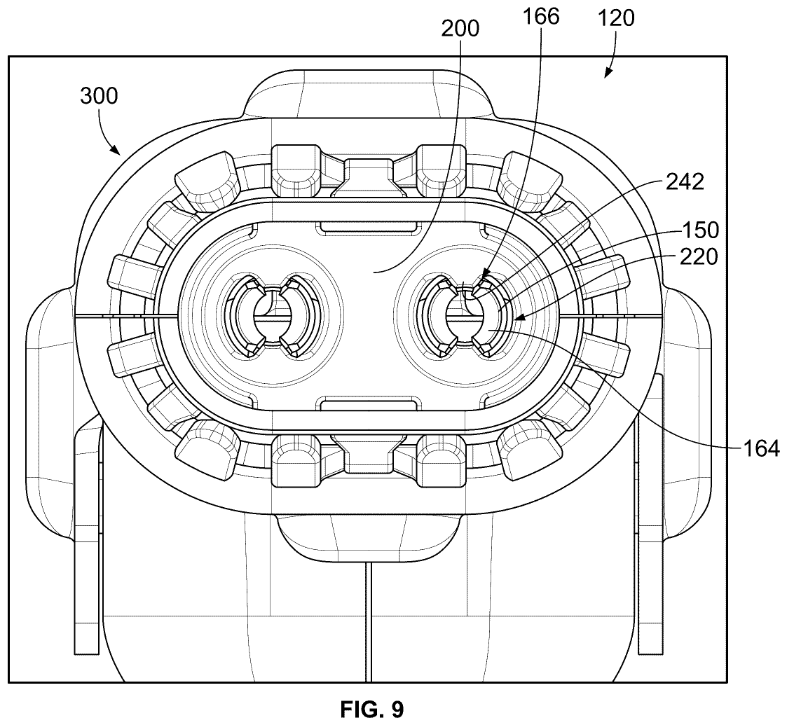

FIG. 9 is a front view of the cable assembly 120 showing the contacts 150 loaded into the dielectric housing 200 and showing the outer shield 300 surrounding the dielectric housing 200. When assembled, the split mating beams 164 interface with the wedges 242. For example, the wedges 242 are received in the gaps 166 between the mating beams 164. The wedges 242, in conjunction with the mating beams 164, form a lead-in to receive the mating pins of the mating electrical connector. The split lead-in increases contact wipe versus previous mating methods that use plastic dielectric lead-ins with the tulip contact recessed behind. Increasing the contact wipe can improve the connector interface impedance. The alignment features of the dielectric housing 200 and the contact 150 align the gaps 166 with the wedges 242. For example, the polarization features 174 and the longitudinal grooves 250 properly oriented the contacts 150 in the contact channels 220.

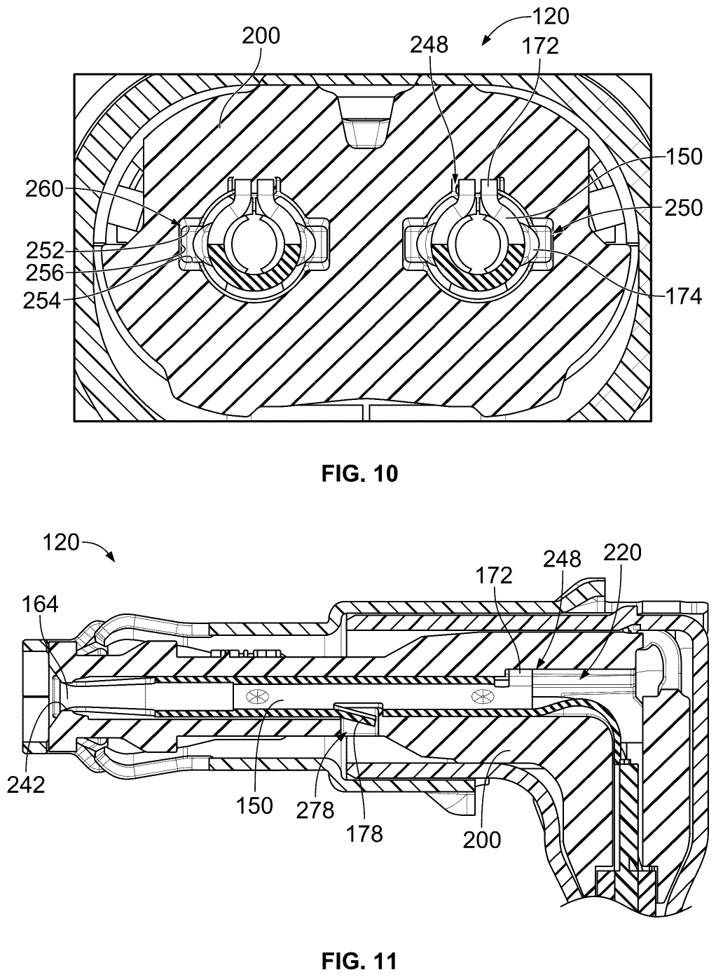

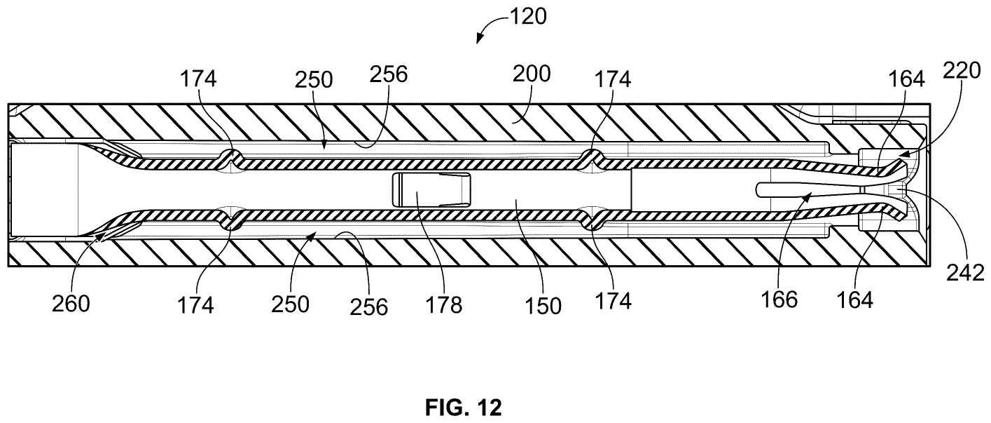

FIG. 10 is a cross-sectional view of the cable assembly 120 showing the contacts 150 loaded into the dielectric housing 200. FIG. 11 is a cross-sectional view of the cable assembly 120 showing the contacts 150 loaded into the dielectric housing 200. FIG. 12 is a cross-sectional view of a portion of the cable assembly 120 showing one of the contacts 150 loaded in the dielectric housing 200. The contacts 150 are located in the contact channels 220. The orientation tabs 172 are located in the orientation pocket 248. The locking lance 178 (FIG. 11) is received in a locking pocket 278 (FIG. 11) in the dielectric housing 200 To secure the contact 150 in the contact channel 220 and prevent pull out of the contact 150 from the dielectric housing 200. The split mating beams 164 (FIG. 12) are aligned on opposite sides of the wedges 242 (FIG. 12), with the wedges 242 located in the gaps 166, to interface the contact 150 with the wedges 242.

During assembly, the polarization features 174 are received in the longitudinal grooves 250. The polarization features 174 are guided into the longitudinal grooves 250 by the funnels 260 as the contact 150 is loaded into the contact channel 220. The polarization features 174 are configured to slide forwardly within the longitudinal grooves 250 as the contact 150 is loaded into the contact channel 220. The first and second groove walls 252, 254 are used to position the polarization features 174 in the longitudinal grooves 250. The first and second groove walls 252, 254 contain the polarization features 174 and the longitudinal grooves 250. Optionally, the spacing between the first and second groove walls 252, 254 may be slightly wider than the polarization features 174 to allow a limited amount of rotation movement of the contact 150 for proper alignment of the contact 150 in the contact channel 220. The first and second groove walls 252, 254 define the limits of such rotational movement.

In an exemplary embodiment, spaces provided around the polarization features 174 within the longitudinal grooves 250. Such space defines an airgap extending along the contact channel 220. The airgap is used for impedance control for the contact 150. The size of the airgap may be controlled to achieve a target impedance for the contact 150. For example, the height of the outer wall 256 and/or the widths of the first and second groove walls 252, 254 and/or the length of the longitudinal grooves 250 defined the amount of air surrounding the contacts 150 the airgaps to control the impedance. In an exemplary embodiment, the longitudinal grooves 250 extend substantially the entire length of the contact channel 220 from the rear to the front. For example, the longitudinal grooves 250 extend to the split beams 164 at the front ends of the contacts 150 to provide impedance control along substantially the entire length of the contact 150. In an exemplary embodiment, the longitudinal grooves 250 extend a majority of the length of the contact channel 220. In the illustrated embodiment, the longitudinal grooves 250 extend greater than 90% of the length of the contact channel 220. The length of the longitudinal groove 250 may be lengthened or shortened for impedance control of the contact 150, such as to achieve a target impedance for the contact 150.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112, sixth paragraph, unless and until such claim limitations expressly use the phrase “means for” followed by a statement of function void of further structure.

What is claimed is:

1. An electrical connector comprising:
a dielectric housing extending longitudinally between a front and a rear, the front configured to be mated with a mating electrical connector, the dielectric housing including a contact channel extending between the front and the rear of the dielectric housing, the dielectric housing including a longitudinal groove extending along the contact channel, the dielectric housing having a funnel associated with the longitudinal groove, the funnel having an inlet at the rear and an outlet aligned with the longitudinal groove, the funnel having an inlet width at the inlet and an outlet width at the outlet narrower than the inlet width; and
a contact received in the contact channel, the contact including a contact body extending along a contact axis between a mating portion and a terminating portion, the terminating portion configured to be terminated to a wire, the mating portion configured to be mated with a mating contact of the mating electrical connector, the mating portion including a polarizing feature extending therefrom received in the longitudinal groove to radially position the contact within the contact channel about the contact axis;
wherein the polarizing feature is guided into the longitudinal groove by the funnel as the polarizing feature passes from the inlet to the outlet of the funnel.

2. The electrical connector of claim 1, wherein the polarizing feature includes a protrusion extending radially outward from the contact body.

3. The electrical connector of claim 1, wherein the polarizing feature is a first polarizing feature, the mating portion including a second polarizing feature radially offset from the first polarizing feature.

4. The electrical connector of claim 1, wherein the polarizing feature is a first polarizing feature, the mating portion including a second polarizing feature axially offset from the first polarizing feature.

5. The electrical connector of claim 1, wherein the polarizing feature slides along the longitudinal groove as the contact is loaded into the contact channel.

6. The electrical connector of claim 1, wherein the longitudinal groove includes a first groove wall, a second groove wall opposite the first groove wall, and an outer wall between the first and second groove walls, the outer wall opposite an opening to the contact channel between the first and second groove walls, the outer wall and the first and second groove walls forming a void defining the longitudinal groove.

7. The electrical connector of claim 1, wherein the longitudinal groove extends a majority of a length of the contact channel between the rear and the front of the dielectric housing.

8. The electrical connector of claim 1, wherein the funnel provides a lead-in to the longitudinal groove.

9. The electrical connector of claim 1, wherein the funnel includes a first funnel wall and a second funnel wall extending between the inlet and the outlet, the polarizing feature being guided into the longitudinal groove by at least one of the first funnel wall and the second funnel wall.

10. The electrical connector of claim 9, wherein the first and second funnel walls are curved.

11. The electrical connector of claim 1, wherein the polarizing feature is configured to interface with the funnel to cause rotation of the contact in the contact channel to orient the contact at a predetermined radial orientation relative to the dielectric housing within the contact channel.

12. The electrical connector of claim 1, wherein the mating portion includes split beams at a front of the contact surrounding the socket, the split beams configured to be mated to the mating contact.

13. The electrical connector of claim 12, wherein the dielectric housing includes wedges extending into the contact channel proximate to the front of the dielectric housing, the split beams being aligned with the wedges by the longitudinal groove to position the split beams on opposite sides of the wedges.

14. The electrical connector of claim 12, wherein the longitudinal groove extends to the split beams of the contact.

15. The electrical connector of claim 1, wherein the longitudinal groove forms an airgap along the mating portion of the contact to control an impedance of the contact.

16. The electrical connector of claim 1, wherein the contact includes a locking lance extending from the contact body, the dielectric housing including a locking pocket, the polarizing feature orienting the contact in the contact channel to align the locking lance with the locking pocket.

17. The electrical connector of claim 1, wherein the contact includes an orientation tab, the dielectric housing including an orientation pocket at the rear, the polarizing feature orienting the contact in the contact channel to align the orientation tab with the orientation pocket.

18. An electrical connector comprising:
a dielectric housing extending longitudinally between a front and a rear, the front configured to be mated with a mating electrical connector, the dielectric housing including a contact channel extending between the front and the rear of the dielectric housing, the dielectric housing including longitudinal grooves extending along the contact channel, the longitudinal grooves being radially spaced apart from each other about the contact channel, the dielectric housing having funnels associated with the longitudinal grooves, the funnels each having an inlet at the rear and an outlet aligned with the corresponding longitudinal groove, each funnel having an inlet width at the inlet and an outlet width at the outlet narrower than the inlet width; and
a contact received in the contact channel, the contact including a contact body extending along a contact axis between a mating portion and a terminating portion, the terminating portion configured to be terminated to a wire, the mating portion configured to be mated with a mating contact of the mating electrical connector, the mating portion including polarizing features extending therefrom, the polarizing features being radially spaced apart from each other about the mating portion, the polarizing features received in the corresponding longitudinal grooves to radially position the contact within the contact channel about the contact axis, wherein the polarizing features are guided into the longitudinal grooves by the corresponding funnels as the polarizing features pass from the inlets to the outlets of the funnels;
wherein the longitudinal grooves form air gaps along the mating portion to control an impedance of the contact.

19. An electrical connector comprising:
a dielectric housing extending longitudinally between a front and a rear, the front configured to be mated with a mating electrical connector, the dielectric housing including a contact channel extending between the front and the rear of the dielectric housing, the dielectric housing including wedges extending into the contact channel proximate to the front of the dielectric housing, the dielectric housing including longitudinal grooves extending along the contact channel, the longitudinal grooves being radially spaced apart from each other about the contact channel, the dielectric housing having funnels at the rear aligned with the longitudinal grooves; and
a contact received in the contact channel, the contact including a contact body extending along a contact axis between a mating portion and a terminating portion, the terminating portion configured to be terminated to a wire, the mating portion configured to be mated with a mating contact of the mating electrical connector, the mating portion including a socket, the mating portion including split beams at a front of the contact configured to be mated to the mating contact, the mating portion including polarizing features extending therefrom, the polarizing features being radially spaced apart from each other about the mating portion, the polarizing features received in the corresponding longitudinal grooves to radially position the contact within the contact channel about the contact axis;
wherein the polarizing features are guided into the longitudinal grooves by the corresponding funnels; and
wherein the split beams are aligned with the wedges by the longitudinal grooves to position the split beams on opposite sides of the wedges.

20. The electrical connector of claim 19, wherein the longitudinal grooves form airgaps along the mating portion of the contact to control an impedance of the contact.
